(19) United States
(12) Patent Application Publication
(10) Pub. No.: US 2013/0211891 A1
(43) Pub. Date: Aug. 15, 2013

(54) SYSTEM AND METHOD FOR MARKETING PRODUCTS OR SERVICES THROUGH AN ONLINE SOCIAL NETWORK

(71) Applicants: Isaac S. Daniel, Miramar, FL (US); Alverto Interian, III, Miramar, FL (US)

(72) Inventors: Isaac S. Daniel, Miramar, FL (US); Alverto Interian, III, Miramar, FL (US)

(21) Appl. No.: 13/752,133

(22) Filed: Jan. 28, 2013

Related U.S. Application Data
(60) Provisional application No. 61/591,574, filed on Jan. 27, 2012.

(51) Int. Cl. G06Q 30/02; G06Q 50/00

(52) U.S. Cl. CPC G06Q 30/0214; G06Q 50/01
USPC 705/14.16

(57) ABSTRACT

A system that includes a processor, computer executable instructions readable by the processor and operative to allow a first user of an online social network to endorse a product or service through the online social network, allow a second user of the online social network to purchase the product or service, and distribute a commission to the first user.

### PRIORITY CLAIM

The present application is a non-provisional patent application of U.S. provisional patent application Ser. No. 61/591,574, titled “System for Marketing Products or Services Through an Online Social Network,” filed on Jan. 27, 2012; the present application is a continuation-in-part of international patent application Ser. No. PCT/US12/34561, titled “Electronic Network Marketing System and Method for Distributing Digital Content Over an Online Social Network,” filed on Apr. 20, 2012, which is a non-provisional of U.S. provisional patent application Ser. No. 61/477,374, titled “Network Marketing System and Method for Distributing Media Over Social Networks,” filed on Apr. 20, 2011; and the present application is a continuation-in-part of U.S. non-provisional patent application serial number 13/722,822, titled “Electronic System and Method for Product Purchasing and Maintenance,” filed on Dec. 20, 2012, which is a non-provisional of U.S. provisional patent application Ser. No. 61/577,856, titled “System and Method for Product Purchasing and Maintenance,” filed on Dec. 20, 2011, whose priorities are claimed by the present application, and which are hereby incorporated by reference as if fully stated herein.

### FIELD

The present disclosure relates generally to electronic systems and methods, and more specifically to electronic systems and method for the distribution and promotion of products and services.

### BACKGROUND

In recent years, the landscape of product and services marketing has changed dramatically. Up until a few years ago, the primary means for marketing products and services were traditional passive marketing channels, namely television advertisements, print advertisements, and billboards.

With the rise in internet usage that occurred in the late 1990's, many marketers began marketing products and services through digital means, such as online banners and search engine marketing. Online social networks have also become immensely popular, with more and more of the world's population spending more and more time on social networking websites. Marketers have adjusted accordingly, and online social networks feature advertisement banners throughout their website.

Problems remain, however, in that the number of leads generated by online advertising remains relatively low.

### SUMMARY

The systems and methods described herein result from the realization that product and service marketing may be improved by providing a network marketing system and method for promoting products and services through online social networks, thereby offering consumers a means to monetize their product purchases recommendations by taking part in a network marketing structure for distributing products and services over online social networks.

Accordingly, the various embodiments and disclosures described herein solve the limitations of the prior art in a new and novel manner.

### BRIEF DESCRIPTION OF THE DRAWINGS:

FIG. 1A shows a system in accordance with one embodiment;

FIG. 1B shows a system in accordance with another embodiment;

FIG. 1C shows a system in accordance with another embodiment;

FIG. 1D shows a system in accordance with yet another embodiment;

FIG. 1E shows a system in accordance with one embodiment;

FIG. 2 shows a flow chart depicting a computer implemented method in accordance with one embodiment; and

FIG. 3 shows a block diagram depicting an apparatus in accordance with one embodiment.

### DETAILED DESCRIPTION:

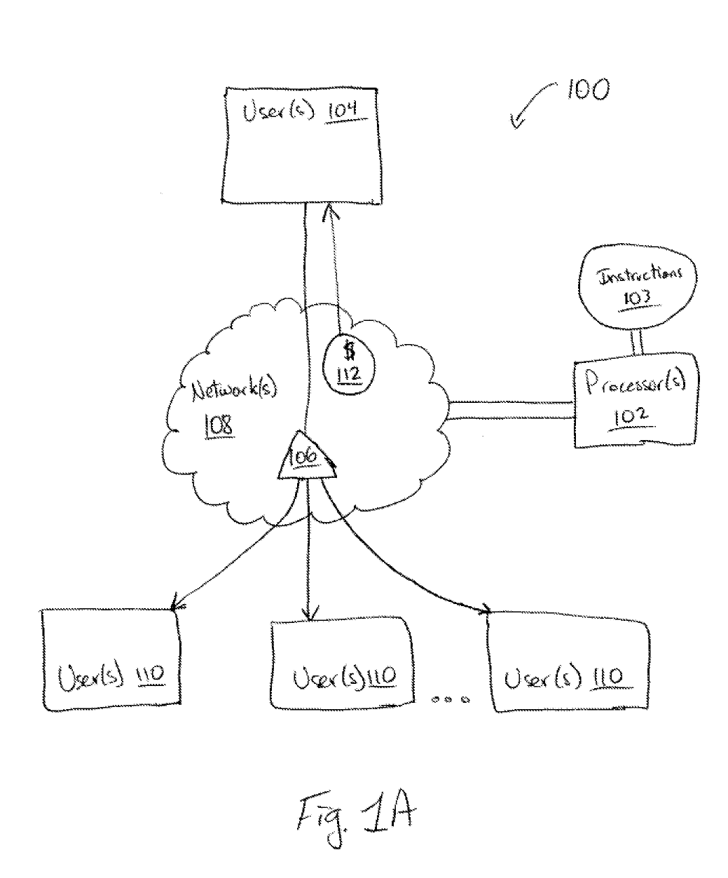

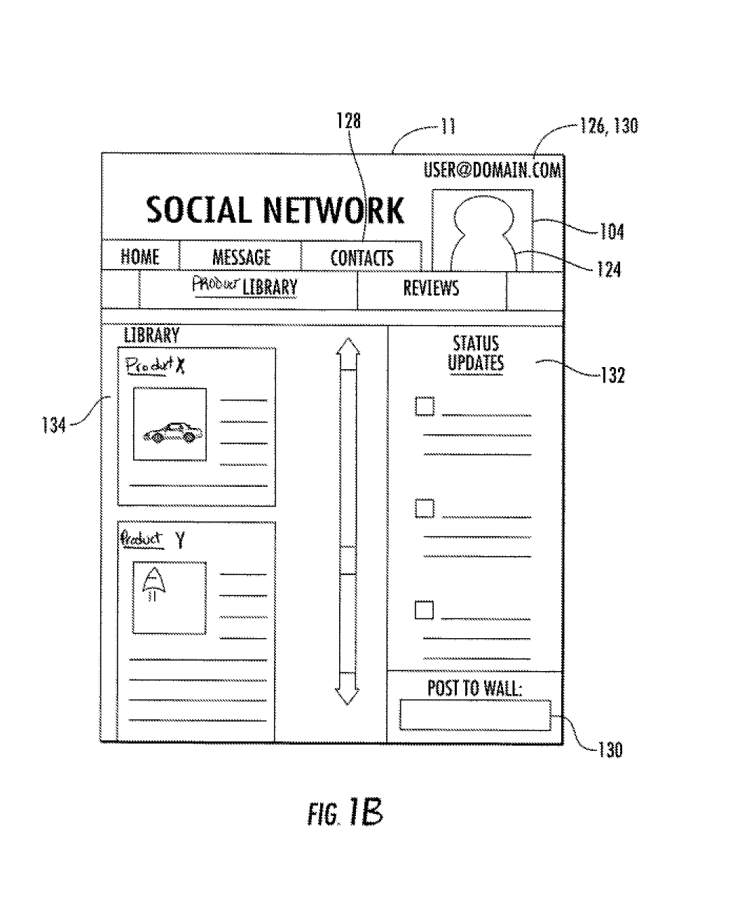

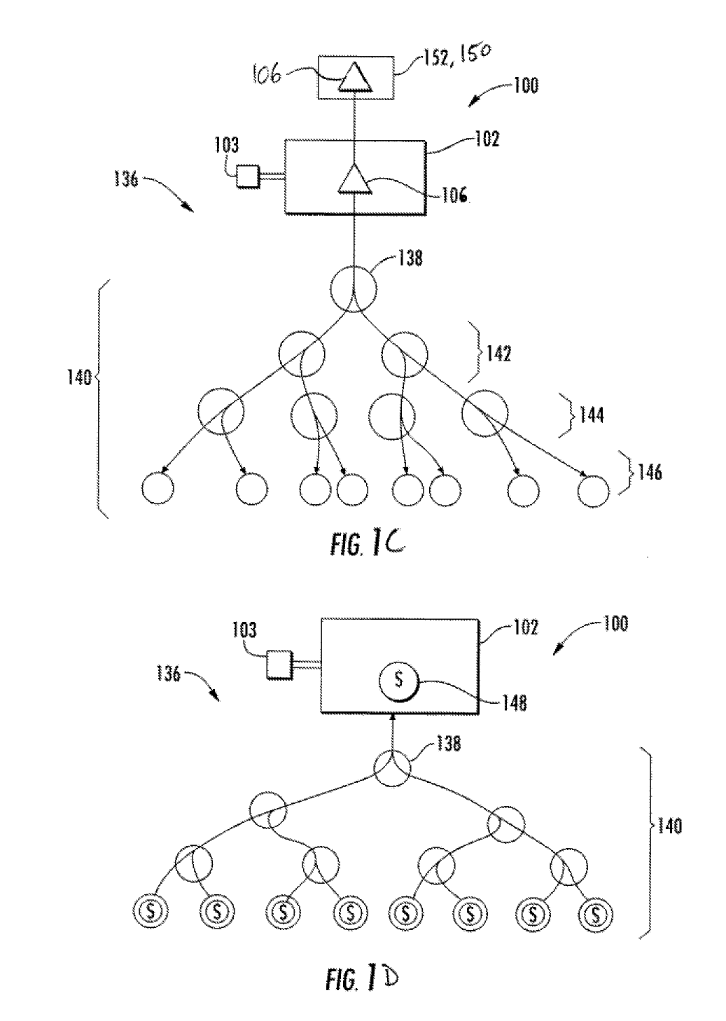

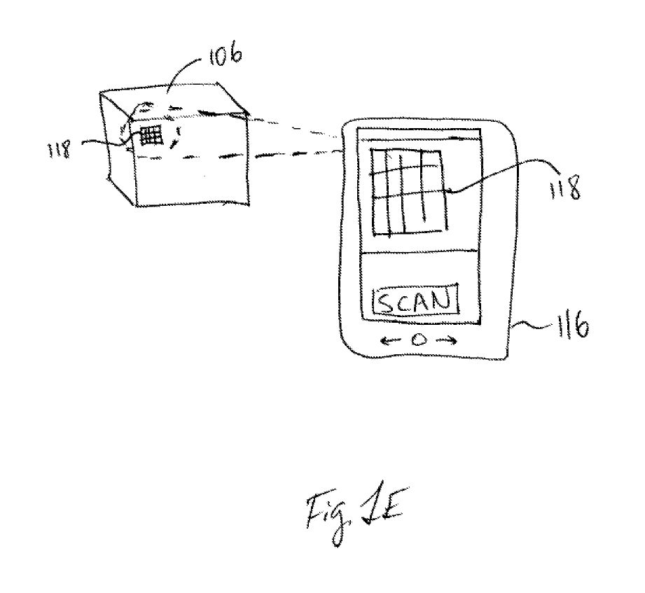

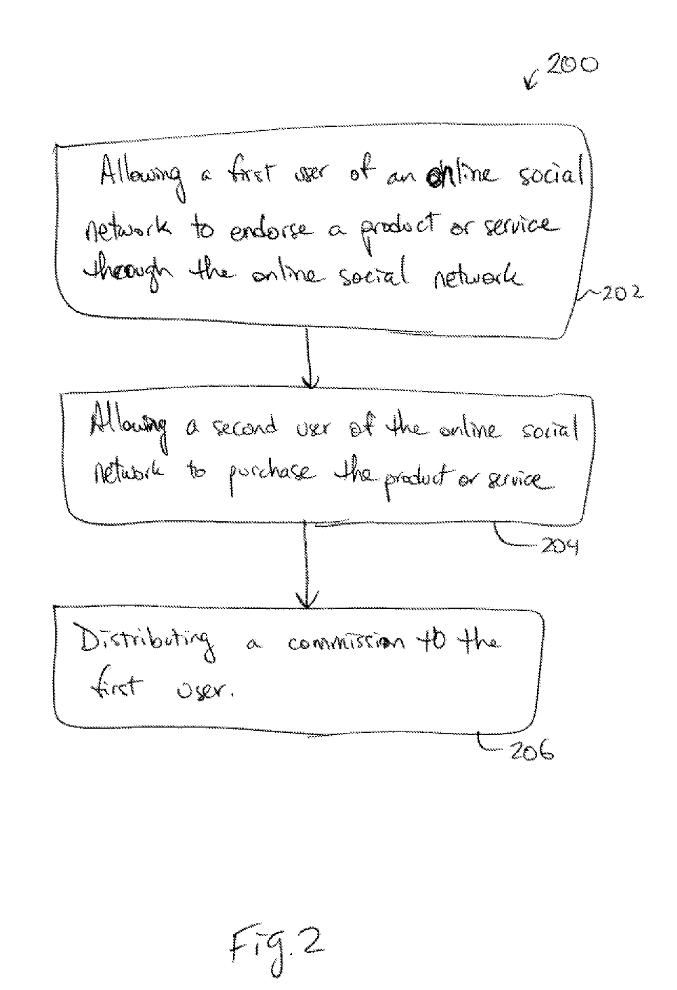

FIG. 1 shows a system 100 in accordance with one embodiment, wherein system 100 comprises at least one processor 102 and computer executable instructions 103 readable by processor 102 and operative to allow at least one first user 104 of an online social network 108 to endorse a product or service 106 through online social network 108, allow at least one second user 110 of online social network 108 to purchase product or service 106, and distribute a commission 112 to first user 104.

In some embodiments, at least one processor 102 may be any type of processor, such as, but not limited to a computer processor, a server processor, a mobile device processor, such as, but not limited to, a single core processor or a multi-core processor.

At least one processor 102 may be connected to, part of, or integrated with a server that hosts social network 108. In yet another embodiment, at least one processor 102 may be connected to, part of, or integrated with a server that distributes endorsements or advertisements for products 106, such as, but not limited to, a content distribution network server, a streaming media server, and the like. In some embodiments, at least one processor 102 may be connected to, part of, or integrated with a server that hosts a social network application that distributes the endorsements/content, such as an application that operates with a social network. In yet another embodiment, at least one processor 102 may comprise multiple processors, wherein each processor may be connected to, part of, or integrated with various servers, such as a content/endorsements distribution server, a social network server, or a social network application server, wherein said severs operate in conjunction to provide the various aspects of system 100, such as providing social network 108, distributing product/service endorsements 106, distributing commission 112, managing user accounts, providing a social network application, and the like; alternatively, at least one processor 102 may manage the these various components of such as system.

As used herein, the terms “connected,” “part of,” or “integrated with,” should be interpreted as referring to an electronic connection or integration, which allows for electronic communication between two electronic components. Said electronic connection may comprise a wireless electronic connection, wired electronic connection, combination thereof, or direct electronic connection, such as in the case with various components that share the same electronic circuit board. In alternate embodiments, said electronic connection may comprise a remote or indirect electronic connection that is enabled by a computer network connection, or a direct connection that is enabled through local wireless communications means (e.g. WiFi, Bluetooth, etc.), through wired communication means, or through sharing a same electronic circuit board.

In some embodiments, computer executable instructions 103 may comprise computer language or other means for embodying computer executable instructions, such as C, C++, C#, Java, Flash, HTML, HTML 5, and the like. Computer executable instructions 103 may be stored on any digital storage means, such as a non-transitory or transitory computer readable medium, which may include a hard drive, flash storage, a CD-ROM, a DVD, and the like. Computer executable instructions 103 may be accessed by processor 102 via a local connection, such as by being directly connected to a computer readable medium in which computer executable instructions 103 are stored, or via a remote connection, such as via a computer network connection.

In some embodiments, endorsing product 106 to second user 110 comprises electronically endorsing product 106 to second user 110. Distributing may comprise streaming endorsements product 106 to second user 110, allowing second user 110 to download endorsement of product 106, or providing second user 110 with rights to access endorsement of product 106, such as access via a computer network. In some embodiments, endorsing product 106 to second user 110 may comprise allowing second user 110 to view endorsement of product/service 106 on one of second user 110's social network contact's user profile, which may include a user profile/page of first user 104.

In one embodiment, endorsement of product 106 may be distributed via a social network application (commonly referred to as an “app”) that operates within social network 108. Accordingly, endorsement of product 106 may be distributed in a social network that exists primarily, or revolves around, the distribution, sharing, marketing, and discussion of products and/or services 106. Alternatively, endorsement of product 106 may be distributed in a social networking application that operates or resides within a more general social network, wherein said social networking application may revolve around the sharing, distribution, marketing, and discussion of products and/or services 106, while the general social network within which the application operates may be for general social networking, such as is this case with Facebook™.

In some embodiments, endorsement of product/service 106 may be distributed to, seeded with, or authorized for distribution by first user 104. In some embodiments, first user 104 may only be allowed to endorse product/service 106 only if user 104 has previously purchased or used product/service 106. Whether or not user 104 is authorized endorse product/service 106 may be controlled by an authorizations manager system, which may comprise authorizations management servers and software. In some embodiments, the authorization may originate from a manufacturer or distributor of product/service 106. In another embodiment, the manufacturer or distributor may request that first user 104 endorse product or service 106, and in another embodiment, first user 104 may request that the manufacturer or distributor allow the first user 104 to endorse the product/service 106.

In some embodiments, allowing first user 104 to endorse product/service 106 may comprise allowing first user 104 to endorse product/service 106 for free (or free of charge). In a further embodiment, allowing first user 104 to endorse product/service 106 may comprise allowing first user 104 to endorse product/service 106 for free so long as first user 104 is an influential user of social network 108. The term “influential social network user,” as used herein, may refer to a user of a social network that has a relatively large network of social network contacts, wherein “relatively large” may be interpreted as having more social network contacts than the average user of the social network. Alternatively, allowing first user 104 to endorse product/service 106 may comprise allowing first user 104 to endorse product/service 106 for free may be done so as long as first user 106 has a certain or pre-determined number of social network contacts. Said certain or pre-determined number of social network contacts may be any number, such as, but not limited to, one thousand (1,000).

In one embodiment, product or service 106, may comprise any type of product or service, such as, but not limited to, retail products, consumer products, professional services, hospitality services, travel services and/or products, digital products, and the like.

In some embodiments, endorsement of product/service 106 may comprise a web hyperlink to a page where a purchaser may purchase product/service 106, more information on product/service, in including specifications, price, availability, and locations where product/service 106 may be purchased, and the like. In some embodiments, the endorsement may comprise a scannable code, such as a barcode, a quick read code, and augmented reality code, and the like, which may link a potential purchaser, such as second user 110, to the aforementioned information. In yet another embodiment, the endorsement may comprise images, video reviews, testimonies, and the like of product/service 106, wherein said images, video reviews, testimonies, and the like may be provided by first user 104 or a manufacturer/distributor of product/service 106.

In one embodiment, social network 108 may be any type of social network, such as but not limited to, a social networking website. In another embodiment, social network 108 may be dedicated primarily to, or revolve around, the distribution, marketing, sharing of products and/or services, such as product/service 106, or products/services in general. In yet another embodiment, social network 108 may comprise a general social network, such as, but not limited to, a type of social network similar to Facebook™, which is dedicated primarily to facilitating social networking interactions

In some embodiments, social network 108 may be accessed via any type of computing device, such as, but not limited to, a PC, a tablet PC, a mobile PC, a smartphone, a handheld PC, and the like.

In some embodiments, users of social network 108 may be represented by a user profile 111 (shown in FIG. 1B). The term “user profile,” as used herein may refer to a web page (as shown in FIG. 1B), or a landing page, representing a social network user, such as user 104, which may include various information, such as photos 124, contact information 126, social network contact (commonly referred to as “friend”) list 128, means for contacting a user 130, a user status update section 132 or “wall,” and other various sections of a user profile. Accordingly, endorsing product/service 106 may comprise posting an endorsement of product/service 106 on a status update section, or a section dedicated to product endorsement, such as a product endorsement wall or product library 134. In another embodiment, endorsing product/service 106 may comprise automatically adding product/service 106 to first user 104's (or second user's 110) product library 134, which may be displayed on profile 110. In yet another embodiment, the section of profile 111 dedicated to endorsing product 106, or simply dedicated to products in general, may actually be part of a social network application that first user 104 may opt-into.

Accordingly, computer executable instructions 103 may be operative to display a product library on first user 104's profile 111, wherein the content library may list products 106 or displays a link to product/service 106, or other information associated with product 106, such as bibliographical information, user reviews, including review by user 104, and the like.

In some embodiments, the endorsement may comprise a web link, a visual code, such as a bar code or quick-read code (“QR Code”), a review of product/service 106, a pre-view or thumbnail image of product 106, and the like. In some embodiments, the endorsement may comprise a review authored by first user 104, wherein first user 104 may try to encourage or discourage his or her social network contacts from purchasing products/services 106 (note: wherever the term “product” or “service” appear, alone or in conjunction, it should be understood that the terms may be interchangeable for purposes of describing the various embodiments of the invention).

In one embodiment, upon accessing first user 104's endorsement of product 106, the computer executable instructions 103 may be operative to present second user 110 with an option to purchase product 106, and credit first user 104 for the sale, for which first user 104 may receive commission 112.

In some embodiments, distributing commission 112 to first user 104 may comprise distributing a monetary commission to first user 104, or distributing a credit- based commission to first user 104. A monetary commission may be distributed electronically, such as through an electronic transfer funds, or physically, such as by mailing a check via a courier or postal service. A credit-based commission may comprise of electronic credits, which although non-monetary, may be used by first user 104 to purchase products or services on social network 108 or within a social network application, which may include additional products/services 106. In some embodiments, the credit-based commission may be exchanged for money. Commission 112 may be any number, including a pre-determined amount. Alternatively, commission 112 may be a percentage of the sale, wherein said percentage may be any amount. In some embodiments, the proceeds of the sale may divided into commission 112, a payment to an operator of social network 108, social network applications, of system 100, manufacturer/distributor/distributor of product 106, owner, producer, or rights holder of product 106, any “up-line” distributors, and the like. The term “up-line” distributor will be defined below, where the network marketing structure is further discussed.

Accordingly, computer executable instructions 103 may be operative to distribute a fee to a product distributor/marketer whenever product 106 is purchased. The product distributor/marketer may be any kind of distributor/marketer, such as a regional distributor, digital distributor, an advertising agency, an up-line distributor, an operator of system 100, and the like.

In embodiments, computer executable instructions 103 may be operative to require first user 104 to install, open, access, opt into, or a authorize social networking application prior to allowing first user 104 to endorse product 106. In some embodiments, first user 104 may be required to install, open, access, opt into, or authorize the social networking application in situations where product 106 is endorsed, distributed, marketed, discussed, purchased, accessed, or otherwise dealt with in the social networking application that operates within social network 108. Accordingly, the social networking application may operate within a social networking environment, such as social network 108.

In yet another embodiment, computer executable instructions 103 may be operative to require second user 110 to open, access, opt into, install, or authorize the social network application prior to purchasing product 106.

The terms “open,” “access,” “opt into,” or “install,” as used above, may refer to the action of prompting a user to authorize a social network application, to access their user information on social network 108, to make changes to their user profiles, to post information (automatically or when prompted) on their user profiles, and to market products to their user contacts. Many social networks require users to authorize a social network application prior to allowing the user to access the application, and allowing the application to access the user's information. This may require having the user agree to certain terms and conditions.

In one embodiment, computer executable instructions 103 may be operative to host a management system to manage the endorsements of product 106 and prevent unauthorized endorsement, access, distribution, or copying of products 106. Such a management system may comprise various mechanisms, such as a digital rights server that communicates with digital rights clients operating on user devices or in social network 108 or a social networking application, digital rights keys, information encryption, and the like. The management system may further comprise an advertisement management system, to determine and report the total number of endorsements for products, how many purchases have been made due to the endorsements, the distribution of commissions, track user purchases, user endorsement/sales performances, and the like.

In yet another embodiment, computer executable instructions 103 may be operative to allow first user 104 or second user 110 to link their social network 108 account with a third party social network provider. Accordingly, account information may be shared between social networks.

The aforementioned embodiments of system 100 may be used to electronically distribute endorsements of products 106 in a social network using a network marketing structure (also referred to as “multi-level marketing”) that leverages the connections between users 138 of the social network and their social network contacts as shown in FIGS. 1C and 1D. Referring now to FIGS. 1C and 1D, various embodiments of system 100 are shown wherein at least one processor 102 and computer executable instructions 103 may be operative to electronically distribute product endorsements 106 in social network 108 using a network marketing structure that leverages the connections between users of social network 108.

In some embodiments, endorsements of products 106 may be distributed or seeded to a user 138 (such as first user 104) at a top of a distribution network 140, who in turn may distribute endorsements of products 106 to their social network contacts 142, who in turn, may distribute endorsements of products 106 to their social network contacts 144, who in turn may distribute it to their social network contacts 146, and so on and so forth. User 138 may comprise first user 104, while one of the social network contacts /users 138, 142 may comprise second user 110, or a third user.

For example, if users 142 endorse products 106 to their social network contacts 144 who purchase products 106, users 144 may earn commissions 148 from the proceeds of that sale, and a commission may also be distributed to all of users 142's distribution upline, which in this case, includes user 138. Accordingly, if users 144 endorse or sell products 106 to their social network contacts 146, then users 144, 142, and 138 may all collect commissions since the sale was in their downline. The terms “upline” and “downline,” as used herein, may refer to persons, in this case, users, who are above or below a certain person in the network marketing organization or structure, also commonly referred to as a “genealogy” of distributors. For example, in FIGS. 1C and 1D, users 138, 142, and 144 are in users 146's upline, and users 142, 144, and 146 are in user 138's downline. Typically, users may collect commissions from their direct downline. In some embodiments, commissions may only be collected up to a certain level of the downline structure. Furthermore, the further down the downline the sale occurs, the smaller the commission a user earns.

Ultimately, however, operator 150 of system 100, which uses processor 102 and computer executable instructions 103 to implement the network marketing system earn proceeds from each sale of the content, no matter how far downline each sale occurs. Furthermore, a commission or royalty may also be paid to a product 106 owner or distributor 152 who provides operator 150 with authorization to endorse products 106.

In this manner, endorsements of products 106 may be distributed with limited marketing and advertising costs, since the marketing is all done by the users of social network 108. Furthermore, users of social network 108 may be incentivized to legally purchase and sell products 106 (and not pirated products), since they may be able to make commissions from sales to their downline. They may also be encouraged to market products 106 by writing reviews, displaying items related to product 106 on their profiles, and develop a following of social network contacts who return to them for suggestions on which products to purchase.

Furthermore, the process of buying products in general may be improved, since users will be able to turn to specific social network contacts whom they trust to recommend products worthy of purchasing.

In some embodiments, users of system 100 may market their own products/services with minimal costs, since they may leverage their social network contacts to distribute their products/services and collect commissions from all downline sales.

In some embodiments, distributing a commission 112 to first user 104 may comprise distributing a commission 112 to first user 104 if second user 110 purchases product or service 106 based on first user 104's endorsement. In some embodiments, whether or not second user 110 purchased product 106 based on first user 104's endorsement may comprise providing second user 110 with a unique link or code (presented to second user 110 or included in meta data) associated with first user 104 or first user 104's endorsement, which may be entered or automatically retrieved at the time of purchase.

In some embodiments, computer executable instructions 103 may be operative to report a purchase of product or service 106 based on first user 104's endorsement. The report may comprise a electronic report, which may be provided to first user 104 or an operator of system 100. In some embodiments, the report may be generated automatically, or may be entered in manually, such as by second user 110 (as described in further detail below).

In some embodiments, allowing first user 104 to endorse a product or service 106 through online social network 108 may comprise allowing first user 104 to endorse product or service 106 to his or her social network contacts. The social network contacts may comprise second user(s) 110. In another embodiment, as previously mentioned, the endorsement comprises or takes the form of a web link distributed to the social network contacts or second user 110. The web link may be a URL hyperlink, or a visual code, such as a QR code or barcode which may be scanned using a mobile device 116 (shown in FIG. 1E. Mobile device 116 may comprise a mobile PC, a mobile phone, a tablet PC, a smartphone, and the like. Upon using mobile device 116 to scan the code in the endorsement, second user 110 may be presented with information on product 106, such as price, where to purchase product 106, an option to purchase product 106, and the various embodiments previously discussed.

In another embodiment, allowing second user 110 to purchase product or service 106 comprises allowing second user 110 to purchase product or service 106 online, such as through an online store, or in-person, such as in a brick-and-mortar retail location.

In a further embodiment, reporting a purchase comprises allowing second user 110 to report the purchase. Allowing second user 110 to report the purchase may comprise allowing second user 110 to report the purchase through online social network 108, such as by entering a code that is provided after the purchase either in or on product packaging, in a receipt, or in an electronic communication (e-mail), mentioning the purchase in a social networking post/message using a pre-designated hash tag or identifier, and the like. In yet another embodiment, allowing second user 110 to report the purchase comprises allowing second user 110 to scan a code 118 located on product or service 106 (or provided by service provider) with mobile device 116 (as shown in FIG. 1E). In some embodiments, by scanning the code 118 with a mobile device 116, the mobile device 116 reports the purchase back to system 100 via a network, such as online social network 108, the internet, a GSM network, and the like.

In yet another embodiment, system 110 comprises rewarding second user 110 for purchasing endorsed product or service 106, such as providing second user 110 with a discount, rebate, cash-back reward, or other reward.

In yet another embodiment, the commission 112 provided to first user 104 comprises a monetary commission, or any other type of reward, such as those described with reference to the reward made to second user 110 above, and throughout the present disclosure.

In another embodiment, computer executable instructions 103 may be operative to allow second user 110 to endorse product/service 106 through online social network 108. In some embodiments, second user 110 may be allowed to endorse product/service 106 only after having purchased product/service 106, or, alternatively, without having purchased product/service 106. In other embodiments, second user 110 may be allowed to endorse product/service 106 in a similar manner to first user 104, as described in the various embodiments in the present disclosure.

In some embodiments, computer executable instructions 103 may be operative to allow a third user of online social network 108 to purchase product/service 106 based on second user 110's endorsement, which may occur in a similar manner to those embodiments described above with reference to second user 110 purchasing a product/service 106 endorsed by first user 104. In some embodiments, computer executable instructions may be operative to distribute commissions to first user 104 and second user 110, wherein said distributions may be made if the third user purchases the product/service 106 based on second user 110's endorsement. The amount of commissions paid to first user 104 and second user 110 may be of equal amounts, or different amounts, wherein first user 104 may receive more or less than second user 110.

In another embodiment, an operator of system 100 or a marketer/distributor of product 106 may receive a commission as well.

It should be noted that in some embodiments described herein, product/service 106 may be represented virtually online, so if it is stated or shown that product/service 106 is being distributed via online social network 108, it should be understood that an endorsement or virtual representation of product/service 106 may be distributed via online social network 108, and not that the product/service 106 is physically being distributed via the online social network 108 (although in the case of digital products/services, this may be the case).

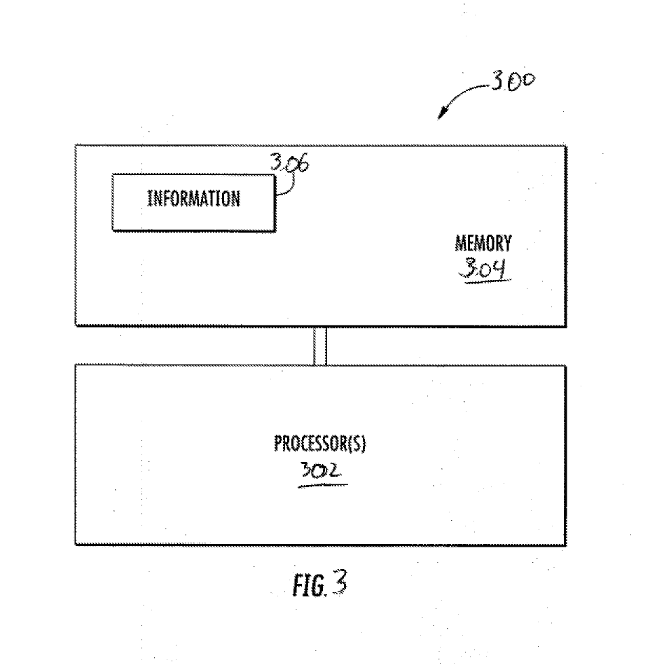

Referring now to FIG. 2, a flow chart depicting a computer implemented method 200 is shown in accordance with one embodiment, wherein method 200 may comprise allowing a first user of an online social network to endorse a product or service through the online social network (block 202), allowing a second user of the online social network to purchase the product or service (block 204), and distributing a commission to the first user (block 206).

In some embodiments, allowing a first user of an online social network to endorse a product or service through the online social network may comprise any or all of those embodiments disclosed above with regards to the steps carried out by system 100 described above and elsewhere throughout the present and previous disclosures.

In another embodiment, allowing a second user of the online social network to purchase the product or service may comprise any or all of those embodiments disclosed above with regards to the steps carried out by system 100 described above and elsewhere throughout the present and previous disclosures.

In yet another embodiment, distributing a commission to the first user may comprise any or all of those embodiments disclosed above with regards to the steps carried out by system 100 described above and elsewhere throughout the present and previous disclosures.

Accordingly, in some embodiments, the endorsement may comprise a web link or scannable code.

Accordingly, in some embodiments, allowing the second user to purchase the product or service comprises allowing the second user to purchase the product online or in-person at a retail location.

Accordingly, in some embodiments, method 200 may further comprise distributing a commission to the first user if the second user purchased the product or service based on the first user's endorsement.

Accordingly, in some embodiments, method 200 may further comprise reporting a purchase of the product or service based on the first user's endorsement. In some embodiments, reporting a purchase comprises allowing the second user to report the purchase.

Accordingly, in some embodiments, method 200 may further comprise allowing the second user to endorse the product or service through the online social network. In some embodiments, method 200 may further comprise allowing a third user of the online social network to purchase the product or service. In another embodiment, method 200 may further comprise distributing commissions to the first user and the second user (which may happen if the third user purchases the product/service based on the second user's endorsement.

The computer that implements method 200 may comprise any type of computer, such as a server, a personal computer, a cloud computing system, a series of computers, and the like, which may be connected to or integrate at least one processor 102 in system 100, and which may comprise a transitory or non-transitory computer readable medium, such as those embodiments described above.

In some embodiments, the steps carried out by method 200 may be carried out by computer executable instructions stored on a non-transitory (or transitory) computer readable medium, such as those various embodiments described elsewhere throughout the present and previous disclosures.

### Hardware and Operating Environment

This section provides an overview of example hardware and the operating environments in conjunction with which embodiments of the inventive subject matter can be implemented.

A software program may be launched from a computer readable medium in a computer-based system to execute the functions defined in the software program. Various programming languages may be employed to create software programs designed to implement the system 100 and method 200 disclosed herein. The programs may be structured in an object-orientated format using an object-oriented language such as Java or C++. Alternatively the programs may be structured in a procedure-oriented format using a procedural language, such as assembly or C. The software components may communicate using a number of mechanisms, such as application program interfaces, or inter-process communication techniques, including remote procedure calls. The teachings of various embodiments are not limited to any particular programming language or environment. Thus, other embodiments may be realized, as discussed regarding FIG. 3 below.

FIG. 3 is a block diagram representing an apparatus 300 according to various embodiments. Such embodiments may comprise a computer, a memory system, a magnetic or optical disk, some other storage device, or any type of electronic device or system. The apparatus 300 may include one or more processor(s) 302 coupled to a machine-accessible medium such as a memory 304 (e.g., a memory including electrical, optical, or electromagnetic elements). The medium may contain associated information 306 (e.g., computer program instructions, data, or both) which, when accessed, results in a machine (e.g., the processor(s) 302) performing the activities previously described herein.

The principles of the present disclosure may be applied to all types of computers, systems, and the like, include desktop computers, servers, notebook computers, personal digital assistants, microcomputers, and the like. However, the present disclosure may not be limited to the personal computer.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

1. A system comprising:
a. a processor;
b. computer executable instructions readable by the processor and operative to:
i. allow a first user of an online social network to endorse a product or service through the online social network;
ii. allow a second user of the online social network to purchase the product or service; and
iii. distribute a commission to the first user.

2. The system of claim 1, wherein the endorsement comprises a web link or scannable code.

3. The system of claim 1, wherein allowing the second user to purchase the product or service comprises allowing the second user to purchase the product online or in-person at a retail location.

4. The system of claim 1, wherein the computer executable instructions are operative to distribute a commission to the first user if the second user purchased the product or service based on the first user's endorsement.

5. The system of claim 1, wherein the computer executable instructions are operative to report a purchase of the product or service based on the first user's endorsement.

6. The system of claim 5, wherein reporting a purchase comprises allowing the second user to report the purchase.

7. The system of claim 6, wherein allowing the second user to report the purchase comprises allowing the second user to scan a code located on the product or service with a mobile device

8. The system of claim 1, wherein the computer executable instructions are operative to allow the second user to endorse the product or service through the online social network.

9. The system of claim 8, wherein the computer executable instructions are operative to allow a third user of the online social network to purchase the product or service.

10. The system of claim 9, wherein the computer executable instructions are operative to distribute commissions to the first user and the second user.

11. A computer implemented method comprising:
a. allowing a first user of an online social network to endorse a product or service through the online social network;
b. allowing a second user of the online social network to purchase the product or service; and
c. distributing a commission to the first user.

12. The method of claim 11, wherein the endorsement comprises a web link or scannable code.

13. The method of claim 11, wherein allowing the second user to purchase the product or service comprises allowing the second user to purchase the product online or in-person at a retail location.

14. The method of claim 11, further comprising distributing a commission to the first user if the second user purchased the product or service based on the first user's endorsement.

15. The method of claim 11, further comprising reporting a purchase of the product or service based on the first user's endorsement.

16. The method of claim 15, wherein reporting a purchase comprises allowing the second user to report the purchase.

17. The method of claim 11, further comprising allowing the second user to endorse the product or service through the online social network.

18. The method of claim 17, further comprising allowing a third user of the online social network to purchase the product or service.

19. The method of claim 18, further comprising distributing commissions to the first user and the second user.

20. A non-transitory computer readable medium containing computer executable instructions operative to:
a. allow a first user of an online social network to endorse a product or service through the online social network;
b. allow a second user of the online social network to purchase the product or service; and
c. distribute a commission to the first user.
